(19) United States
(12) Patent Application Publication
(10) Pub. No.: US 2004/0203169 A1
(43) Pub. Date: Oct. 14, 2004

(54) Device and process for determining the concentration of at least one gas component in a breathing gas mixture

(76) Inventors: Peter Dreyer, Pansdorf (DE); Horst-Dieter Hattendorff, Bad Schwartau (DE); Jochim Koch, Ratzeburg (DE); Dieter Weismann, Gross Gronau (DE); Hans Matthiessen, Bad Schwartau (DE); Bernd Dicks, Ratekau (DE); Jordis Konig, Torgau (DE)

Correspondence Address: MCGLEW & TUTTLE, PC, 1 SCARBOROUGH STATION PLAZA, SCARBOROUGH, NY, 10510-0827, US

(21) Appl. No.: 10/771,105

(22) Filed: Feb. 3, 2004

(30) Foreign Application Priority Data
Apr. 8, 2003 (DE) 103 15 864.2

(51) Int. Cl. G01N 21/00

(52) U.S. Cl. 436/164; 422/83

(57) ABSTRACT

A device and process are provided for determining the concentration of at least one gas component in a breathing gas mixture. The device is used especially to determine the concentration of a trace gas for a lung function measurement. The requirements on such a device are compact design with low weight, and the requirement on the process is high speed of measurement. For the case of the determination of the concentration of a gas component in a breathing gas mixture, the device has two detectors designed as thermopiles (3, 4) for the infrared optical radiation of a radiation source (1), of which the first thermopile (3) is used alternatingly as a reference detector and for the determination of the concentration of a trace gas for the lung function measurement, and the second thermopile (4) is used to determine the concentration of a gas component in the breathing gas mixture. The device preferably has a two-layer housing structure (5), comprising an outer, heat-insulating layer (6) and an inner layer (7) with good thermal conductivity and high heat capacity.

### FIELD OF THE INVENTION

The present invention pertains to a device for determining the concentration of at least one gas component in a breathing gas mixture as well as to a corresponding process.

### BACKGROUND OF THE INVENTION

Devices for determining the concentration of gas components in a breathing gas mixture are used, among other things, for determining the composition of the breathing gas mixture in a patient with a time resolution of individual breaths or for performing lung function measurements, for instance by determining the functional residual capacity by means of a trace gas and a high-speed infrared optical sensor. In this context, high-speed means that the concentration of gas components is determined in the main stream of the breathing gas mixture and is resolved on the timescale of individual breaths.

EP 651 244 B1 discloses a device for gas analysis with an infrared optical radiation source and a thermopile as a detector, which measures the absorption of the infrared optical radiation in a breathing gas mixture, on the basis of which the concentration of a corresponding gas component can be determined. Thermopiles as detectors have advantages in several respects. Contrary to, e.g., pyroelectric detectors, they can be operated without modulation, so that neither mechanical choppers of a complicated design nor electric pulsing of thermal light sources, leading to slower response time, are necessary. However, it shall be borne in mind in the case of the use of thermopiles as detectors errors of measurement may occur due to variations in the ambient temperature.

### SUMMARY OF THE INVENTION

The object of the present invention is to improve a device for measuring the concentration of at least one gas component in a breathing gas mixture by means of an infrared optical radiation source and a thermopile as a detector as well as a process for determining the concentration of at least one gas component in a breathing gas mixture, so that lung function measurements can thus be additionally performed, wherein the device has a small and compact design and the process responds rapidly.

According to the invention, a device for determining the concentration of at least one gas component in a breathing gas mixture is provided comprising a radiation source for generating infrared optical radiation in the wavelength range of the absorption bands of the gas components, whose concentrations are to be determined, as well as in the wavelength range of the absorption band of a trace gas that can be used for measuring the lung function. A gas measuring cell is arranged in the ray path of the infrared optical radiation source and accommodates the breathing gas mixture to be analyzed, which is led past in a main stream. At least two detectors, designed as thermopiles, are arranged in the ray path of the infrared optical radiation source following the gas measuring cell. Detectors other than thermopiles are also conceivable for this purpose. To keep the entire device small and compact, the number of detectors used equals the number of different gas components in the breathing gas mixture whose concentration is to be determined, plus another, additional detector, which is used as a reference detector and is therefore designed for the measurement of the infrared optical radiation in the wavelength range of the absorption band of the trace gas.

In an advantageous embodiment the gas measuring cell and the detectors designed as thermopiles are surrounded by a housing structure which extensively shields these thermopiles from temperature variations in the environment. This is achieved by means of a two-layer structure of the housing. An outer layer, preferably one made of a plastic, is used for heat insulation, and an inner layer, e.g., one made of aluminum, has good thermal conductivity itself, on the one hand, and high heat capacity, on the other hand. The use of plastic and aluminum has, moreover, the advantage that the weight of the entire device can thus be kept low.

Sulfur hexafluoride or fluorinated hydrocarbons, e.g., fluoropropanes, are very well suited for use as trace gases for measuring the lung function, because they have highly pronounced absorption bands in the infrared optical wavelength range. The detector used as the reference detector is therefore preferably designed for the measurement of the infrared optical radiation in the wavelength range of the absorption band of the said trace gases.

Means for bundling the infrared optical radiation in the ray path between the radiation source and the thermopiles are provided. These may be, e.g., planoconvex lenses, a parabolic reflector and a planoconvex lens arranged correspondingly or an elliptical reflector.

A band pass filter is preferably arranged in the ray path directly in front of each thermopile. The filter lets infrared optical radiation pass through only in the wavelength range of the absorption band of the gas component or of the trace gas whose concentration is to be determined by the thermopile.

In another preferred embodiment of the device the shielding action of the housing structure against temperature changes in the environment is supported by means for regulating the temperature within the housing structure, which is designed, e.g., as a proportional-integral controller. As an alternative to this, means for compensation using a temperature measurement are conceivable.

The process of determining the concentration of at least one gas component in a breathing gas mixture comprises a plurality of steps. Infrared optical radiation of a radiation source in the wavelength range of the absorption bands of the gas components, whose concentrations are to be determined, as well as in the wavelength range of the absorption band of a trace gas that can be used for the lung function measurement is sent through a gas measuring cell, which contains the breathing gas mixture to be analyzed. A first detector, which is arranged in the ray path of the radiation source following the gas measuring cell, is used at first as a reference detector for the other detectors, which measure the infrared radiation in the wavelength range of the absorption bands of the gas components whose concentrations are to be determined. The first detector is subsequently used for the measurement of the infrared optical radiation in the wavelength range of the absorption band of the trace gas. The process according to the present invention may be carried out, e.g., in such a way that the concentrations of gas components in the breathing gas mixture are determined over a period of several hours, the first detector being used as a reference detector. The determination of the concentration of the trace gas in the breathing gas mixture (which determination is necessary for measuring the lung function of a patient), which trace gas was introduced into the patient's lungs before, is then performed at time intervals of, e.g., 15 minutes to one hour. Accordingly, the first detector is used most of the time as a reference detector, an interruption taking place only for the purpose of a lung function measurement with a trace gas.

An exemplary embodiment of the device according to the present invention is shown in the drawings and will be described below. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 is a longitudinal sectional view of a device according to the present invention for determining the concentration of a gas component in a breathing gas mixture; and

FIG. 2 is a schematic partially broken away view showing the device of FIG. 1 with a temperature regulating system for regulating the temperature within the housing structure.

### DESCRIPTION OF THE PREFERRED EMBODIMENTS

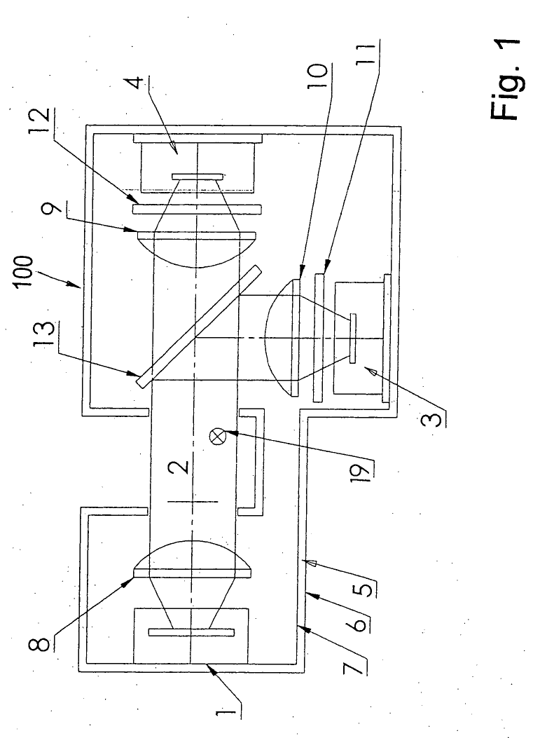

Referring to the drawings in particular, FIG. 1 schematically shows the longitudinal section of a device generally designated 100 for determining the concentration of a gas component in a breathing gas mixture in the plane of the ray path of the infrared optical radiation source 1, which is designed as a so-called membrane radiator. A gas measuring cell 2 is arranged in the ray path, through which the breathing gas mixture passes as a main stream 19, indicated by the arrow pointing perpendicularly to the plane of FIG. 1. A dichroic beam splitter 13 is located behind the gas measuring cell when viewed in the direction of the ray path. A first planoconvex lens 8 located in front of the gas measuring cell 2 and a second and third planoconvex lens 9, 10 located behind the dichroic beam splitter 13, which are reached by respective parts of the infrared optical radiation split by the beam splitter 13, are provided here as means for bundling the infrared optical radiation. Each path first has a band pass filter 11, 12. Directly behind band pass filter 11, a first thermopile 3 is located. A second thermopile 4 is located behind band pass filter 12. The filters 11 and 12 are located behind the second and third planoconvex lenses 10 and 9 respectively, when viewed in the direction of the ray path.

The first thermopile 3 is used alternatingly both as a reference detector for the second thermopile 4 and also for determining the concentration of a trace gas during a lung function measurement, and the second thermopile 4 is used to determine the concentration of a gas component in the breathing gas mixture. The gas measuring cell 2 and the thermopiles 3, 4 are surrounded by a housing structure 5, which has an outer, heat-insulating layer 6 and an inner layer 7 with good thermal conductivity and high heat capacity.

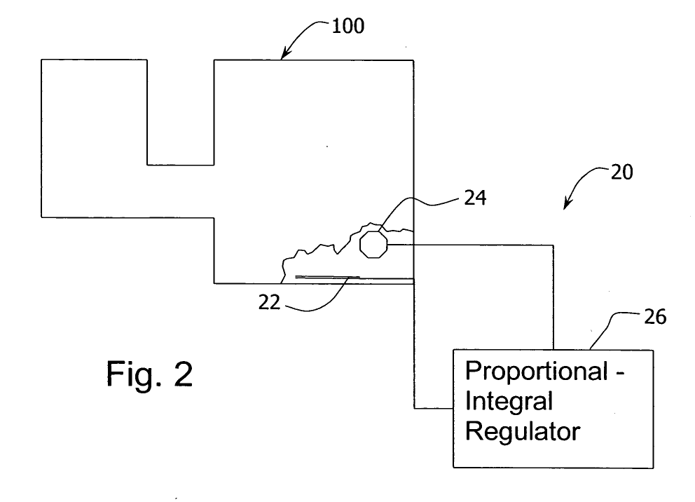

The shielding action of the housing structure against temperature changes in the environment is supported in another preferred embodiment as shown schematically in FIG. 2. The device 100 of FIG. 2 is provided with a temperature controlling system 20 for regulating the temperature within the housing structure 5. The temperature controlling system 20 includes a heating element 22, in contact with inner layer 7 with good thermal conductivity. A temperature sensor 24 senses the temperature within the housing structure 5. The temperature sensor 24 and the heating element 22 are connected to a proportional-integral controller 26. As an alternative to this, means for compensation using a temperature measurement may be provided.

While specific embodiments of the invention have been shown and described in detail to illustrate the application of the principles of the invention, it will be understood that the invention may be embodied otherwise without departing from such principles.

What is claimed is:

1. A device for determining the concentration of at least one gas component in a breathing gas mixture, the device comprising:
a radiation source for generating infrared optical radiation in the wavelength range of the absorption bands of the at least one gas component for which gas concentrations are to be determined, as well as in the wavelength range of the absorption band of a trace gas that can be used to measure the lung function;
a gas measuring cell arranged in the ray path of said infrared optical radiation source, the gas measuring cell containing the breathing gas mixture to be analyzed; and
at least two thermopile detectors arranged following said gas measuring cell in a ray path of said infrared optical radiation source, wherein a first of said detectors is designed both for measuring the infrared optical radiation in the wavelength range of the absorption band of the trace gases and as a reference.

2. A device in accordance with claim 1, further comprising a housing structure surrounding said gas measuring cell and said detectors, said housing structure comprising an outer heat-insulating layer and a inner layer with good thermal conductivity and high heat capacity.

3. A device in accordance with claim 2, wherein said outer heat-insulating layer of said housing structure comprises a plastic and said inner layer with good thermal conductivity is made of aluminum.

4. A device in accordance with claim 1, further comprising means for bundling the infrared optical radiation arranged in the ray path between said radiation source and said detectors.

5. A device in accordance with claim 1, further comprising a band pass filter arranged respectively in the ray path directly in front of each of said detectors.

6. A device in accordance with claim 2, further comprising means for regulating the temperature within said housing structure.

7. A device in accordance with claim 6, wherein said means for regulating the temperature includes a proportional-integral controller.

8. A process for determining the concentration of at least one gas component in a breathing gas mixture, the process comprising the steps of:
sending infrared optical radiation of a radiation source in the wavelength range of the absorption bands of the gas components, whose concentration is to be determined, as well as in the wavelength range of the absorption band of a trace gas that can be used for lung function measurement through a gas measuring cell, which contains the breathing gas mixture to be analyzed;
arranging a first detector in the ray path following said radiation source and said gas measuring cell;
arranging a second detector in the ray path following said radiation source and said gas measuring cell;
using the second detector to measure the infrared optical radiation in the wavelength range of the absorption bands of the gas components whose concentrations are to be determined;
using the first detector as a reference detector for the second detector; and
using the first detector to measure the infrared optical radiation in the wavelength range of the absorption band of the trace gas.

9. A gas sensing device comprising:
a radiation source generating infrared optical radiation;
a gas measuring cell arranged in the ray path of said infrared optical radiation source, the gas measuring cell containing a gas mixture to be analyzed;
a first thermopile detector arranged following said gas measuring cell with respect to a ray path of said infrared optical radiation source, said first detector being designed for measuring an infrared optical radiation in a wavelength range of an absorption band of a trace gas; and
a second thermopile detectors arranged following said gas measuring cell with respect to a ray path of said infrared optical radiation source.

10. A device in accordance with claim 9, further comprising a housing structure surrounding said gas measuring cell and said first detector and said second detector, said housing structure comprising an outer heat-insulating layer and a inner layer with good thermal conductivity and high heat capacity.

11. A device in accordance with claim 10, wherein said outer heat-insulating layer of said housing structure comprises a plastic and said inner layer with good thermal conductivity is made of aluminum.

12. A device in accordance with claim 9, further comprising means for bundling the infrared optical radiation arranged in the ray path between said radiation source and said detectors.

13. A device in accordance with claim 9, further comprising a band pass filter arranged respectively in the ray path directly in front of each of said detectors.

14. A device in accordance with claim 10, further comprising means for regulating the temperature within said housing structure.

15. A device in accordance with claim 14, wherein said means for regulating the temperature includes a proportional-integral controller.
